(19) United States
(12) Patent Application Publication
(10) Pub. No.: US 2004/0134120 A1
(43) Pub. Date: Jul. 15, 2004

(54) Fishing line sinker

(76) Inventor: Rodney Long, Banning, CA (US)

Correspondence Address: James E. Brunton, Esquire, Post Office Box 29000, Glendale, CA, 91209-9000, US

(21) Appl. No.: 10/746,393

(22) Filed: Dec. 24, 2003

Related U.S. Application Data
(60) Provisional application No. 60/437,086, filed on Dec. 27, 2002.

(51) Int. Cl. A01K 91/00; A01K 93/00; A01K 95/00

(52) U.S. Cl. 43/44.87

(57) ABSTRACT

A fishing line sinker comprising a streamlined, weighted body that is provided with an angularly inclined line bore that is strategically placed in an ideal position proximate either the center or the upper end of the sinker. This unique design permits the sinker to freely glide over solid bottom debris without snagging. More particularly, the novel design permits the fishing line to lift the upper portion of the sinker over obstructions without any frontal contact of the sinker.

### BACKGROUND OF THE INVENTION

1. Field of the Invention

The present invention relates generally to sinkers for use in fishing. More particularly, the invention concerns an improved fishing line sinker that is specially designed for fishing rocks structures.

1. Description of the Prior art

A large number of fishing sinker designs have been suggested in the past. One very common and widely used sinker is that described in U.S. Pat. No. 2,701,427 issued to Veranda. The Veranda invention concerns a round shot type sinker having a slot that extends through the sinker. The sinker can be easily attached to a fishing line above the hook by pinching the sinker around the line. Although this type of a sinker enjoys widespread popularity, it has certain drawbacks. For example, the line usually passes through the sinker in an off-center position and the rounded stubby shape of the sinker allows the sinker to catch on weeds as it is pulled through the water.

Another highly successful type of prior art sinker in which the line passes through the center of the sinker is exemplified by a prior art sinker sold by the Mojo Lure Company of Banning, Calif., which is the assignee of the present invention. This sinker has an elongated body that is provided with a centrally disposed line-receiving passageway. In using this device the fishing line is first inserted through the line-receiving passageway. Next, a wire threader is threaded through the central passageway of the sinker and one or more rubber strips are attached to the threaded. Using the threader, the rubber strips are pulled through the sinker body in a manner to slidably affix the sinker to the line.

The fishing line sinker of the present invention comprises a substantial improvement over prior art designs and provides the weight system that is substantially snag free. More particularly, the fishing line sinker of the present invention is very useful when being cast and retrieved in areas that all are heavily blanketed with vast amounts of rock, such as rocky shorelines, damn walls, retainers with pilings, rocky dam walls and isolated hard bottom structures.

### SUMMARY OF THE INVENTION

By way of brief summary, the present invention comprises a fishing line sinker comprising a streamlined, weighted body that is provided with an angularly inclined line bore that is strategically placed in an ideal position proximate either the center or the upper end of the sinker. This unique design permits the sinker to freely glide over solid bottom debris without snagging. More particularly, the novel design permits the fishing line to lift the upper portion of the sinker over obstructions without any frontal contact of the sinker.

The leader line and rigged hook with the selected bait develops enough resistance to hold the elongated sinker in a substantially vertical position as the sinker passes over the solid bottom debris. Because the sinker is maintained in this substantially vertical orientation and because of its streamlined configuration it tends to positively resist snagging even in a hostile rocky environment. Further, the novel, angularly extending fishing line bore encourages the sinker to pivot relative to the fishing line and to controllably adjust the degree of camber angle for ultimate snag free performance while passing over and through rocky obstructions.

With this construction, in most situations, should the weight become snagged, the weight can be expeditiously freed by exerting upward, jerking pressures on the fishing line.

Normally, the sinker is free to slide along the fishing line, but if desired can be secured to the line using a conventional rubber securement device of the character manufactured and sold by the Mojo Lure Company of Banning, Calif.

It is an object of the present invention to provide a novel fishing line sinker that is ideally suited for use in fishing areas that all are heavily blanketed with vast amounts of rock.

Another object of the invention of is to provide a fishing line sinker of the aforementioned character in which the sinker includes a streamlined, weighted body that is provided with an angularly inclined line bore that is strategically placed proximate the upper end of the sinker. Another object of the invention is to provide a fishing line sinker of the type described in the preceding paragraph in which the fishing line tends to lift the upper portion of the sinker over obstructions without any frontal contact of the sinker with the rock obstructions.

Another object of the invention is to provide a fishing line sinker in which, during use, the leader line and rigged hook with the selected bait develops enough resistance to hold the elongated sinker in a substantially vertical position as the sinker passes over the solid bottom debris.

Another object of the invention is to provide a fishing line sinker of the type described in the preceding paragraphs in which the novel, angularly extending fishing line bore formed in the upper portion of the sinker body encourages the sinker to pivot relative to the fishing line and to controllably adjust the degree of camber angle for ultimate snag free performance while passing over and through rocky obstructions.

Another object of the invention is to provide a fishing line sinker, which, in normal. use is free to slide along the fishing line.

Another object of the invention is to provide a novel fishing line sinker that is easy to use, is of simple construction and is inexpensive to manufacture.

### BRIEF DESCRIPTION OF THE DRAWINGS

FIG. 1 is a generally diagrammatic, perspective view showing the fishing line sinker of the invention interconnected with a conventional fishing rig.

FIG. 2 is an enlarged, cross-sectional view of the fishing line sinker shown in FIG. 1.

FIG. 3 is a cross-sectional view of an alternate form of fishing line sinker of the present invention.

FIG. 4 is a cross-sectional view of still another form of fishing line sinker of the present invention.

FIG. 5 is a cross-sectional view of yet another form of fishing line sinker of the present invention.

FIG. 6 is a generally diagrammatic, perspective view, partially in cross-section, showing the fishing line sinker of FIG. 2 interconnected with a conventional fishing rig and in a first position proximate a rock obstruction.

FIG. 7 is a generally diagrammatic perspective view, partially in cross-section, similar to FIG. 6, but showing the sinker having been pivotally moved by the rock obstruction into a second position.

FIG. 8 is a generally diagrammatic, perspective view showing the fishing line sinker of the invention interconnected with an alternate type of swivel-less fishing rig.

FIG. 9 is a generally diagrammatic, perspective view showing the fishing line sinker of the invention interconnected with still another type of fishing rig wherein the sinker is restrained against movement along the fishing line.

### DESCRIPTION OF THE INVENTION

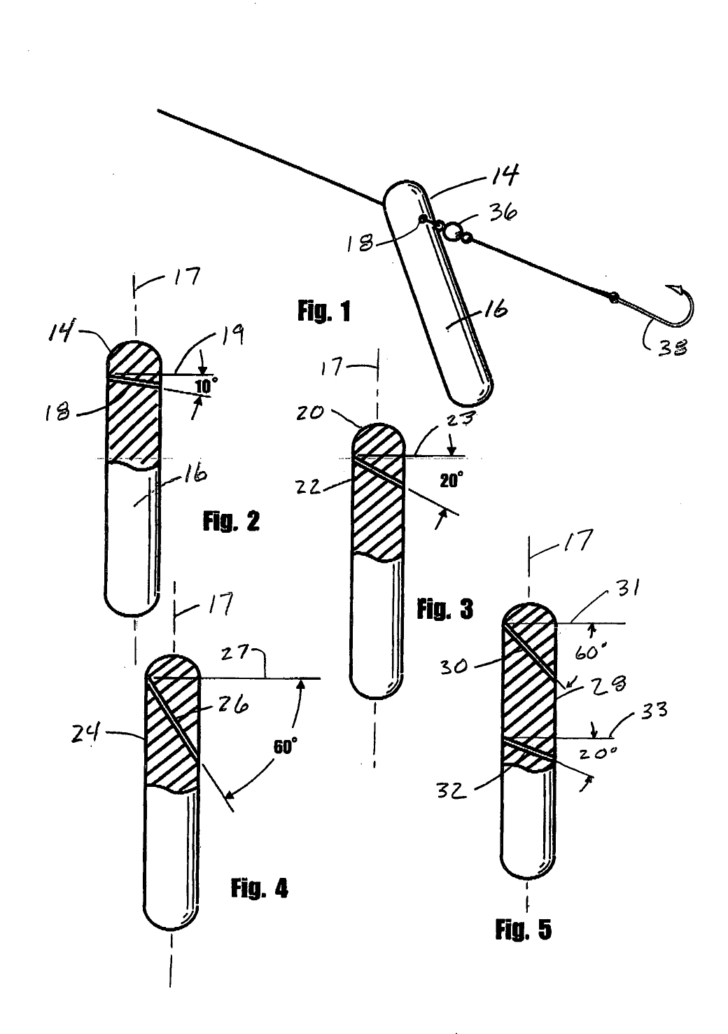

Referring to the drawings and particularly to FIG. 1, one form of the fishing line sinker of the present invention is there illustrated and generally identified by the numeral 14. In this form of the invention, sinker 14 comprises a weighted body 16 having an axial centerline 17, an angularly inclined fishing line bore 18 provided proximate the upper portion of the sinker body. As indicated in FIG. 2, bore 18 extends an angle of approximately 10 degrees downwardly from a horizontal line 19 that is perpendicular to axial center line 17. As will be described in greater detail in the paragraphs, which follow, the fishing line receiving bore can extend at an angle between about 10 degrees and about 60 degrees relative to line extending perpendicularly to axial center line 17. While weighted body 16 can be of various configurations, a generally cylindrically shaped, elongated body shape having rounded end portions is preferable.

Turning to FIG. 3, an alternate form of fishing line sinker of the invention is there illustrated and generally designated by the numeral 20. This alternate form of fishing line sinker is of a similar configuration to that shown in FIG. 2, but the fishing line bore 22 formed in the upper portion of the sinker here extends an angle of 20 degrees relative to a horizontal line 23 that is perpendicular to axial center line 17.

Referring to FIG. 4, still another form of fishing line sinker of the invention is there illustrated and generally designated by the numeral 24. This alternate form of fishing line sinker is also of a similar configuration to that shown in FIG. 2, but the fishing line bore 26 formed in the upper portion of the sinker here extends an angle of 60 degrees relative to a horizontal line 27 that is perpendicular to axial center line 17.

Turning to FIG. 5, yet another form of fishing line sinker of the invention is there illustrated and generally designated by the numeral 28. This alternate form of fishing line sinker is of a similar configuration to that shown in FIG. 2, but the fishing line sinker is here provided with vertically spaced apart fishing line bores 30 and 32. In this form of the invention fishing line bore 30 extends an angle of approximately 60 degrees with respect to a horizontal line 31, while angularly extending fishing line bore 32 extends an angle of approximately 20 degrees relative to a horizontal line 33. In this latest form of the fishing line sinker construction the fishing line may be selectively passed through either fishing line bore 30 or fishing line bore 32 depending upon the particular terrain of the fishing ground.

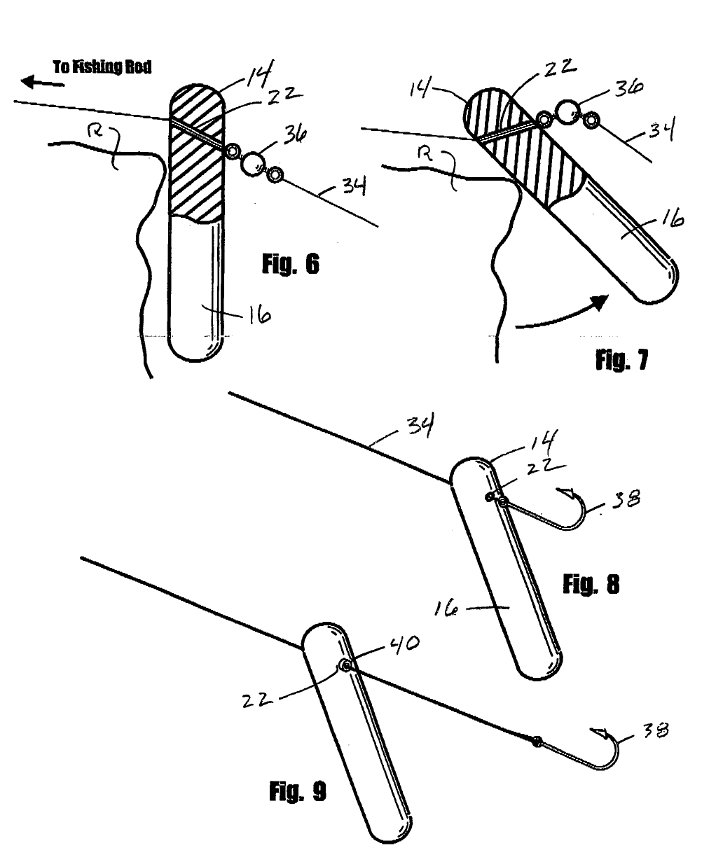

Referring next to FIG. 6, This figure is a generally diagrammatic, perspective view showing the fishing line sinker of FIG. 2 interconnected with a conventional fishing rig with the sinker and in a first position proximate a rock obstruction “R”. FIG. 7 is a generally diagrammatic perspective view similar to FIG. 6, but showing the sinker having been pivotally moved by the rock obstruction “R” into a second upwardly pivoted position.

As illustrated in FIG. 6, the leader line 34, the conventional swivel 36 and the hook with the selected bait (not shown) develops enough resistance to hold the elongated sinker in a substantially vertical position as the sinker passes over the solid bottom debris. Because the sinker is maintained in this substantially vertical orientation and because of its streamlined configuration, as depicted in FIG. 7, the sinker and tends to positively resist snagging in even a hostile rocky environment. More particularly, as shown in FIG. 7, the angularly extending fishing line bore 22 encourages the sinker to pivot relative to the fishing line as the sinker encounters the rock protuberance and in this way mitigates against the sinker becoming snagged or locked against the rock protuberance. Additionally, it is apparent that a pulling force exerted on the fishing line in the direction of the arrow of FIG. 6 will further cause the sinker to pivot about the protuberance in the manner shown in FIG. 7. Should the sinker become wedged between two rock protuberances, shaking the rod tip will cause the sinker to pivot back and forth encouraging it free itself from the rock protuberances.

FIG. 8 illustrates an alternate form of rigging, wherein swivel is absent and the sinker is free to slide the full-length of the fishing line and to move into engagement with the hook 38. It is to be understood that with the sinker in the position shown in FIG. 8, it will nevertheless tend to pivot over and about a rock protuberance in the same manner as illustrated in FIG. 7.

As previously mentioned, the sinker is normally free to slide along the fishing line in a manner shown in FIG. 8. However, if desired the sinker can be secured to the line in the manner shown in FIG. 9 using securement means comprising a conventional rubber securement device 40 which is positioned within fishing line receiving bore 22 and is of the character manufactured and sold by the MOJO LURE COMPANY of Banning, Calif. under the name and style Mojo Sinker Stop. With this construction, while the sinker is restrained from sliding along the line, it will nevertheless tend to pivot about a rock protuberance in the same manner as illustrated in FIG. 7 of the drawings.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. A fishing line sinker for use with a fishing line comprising an elongated body having an axial centerline, an upper portion and a lower portion, said upper portion, a central portion being provided with a first angularly extending fishing line receiving bore for slidably receiving the fishing line.

2. The fishing line sinker as defined in claim 1 in which said elongated body is generally cylindrical in shape.

3. The fishing line sinker as defined in claim 1 in which said fishing line receiving bore extends at an angle between about 10 degrees and about 60 degrees relative to line extending perpendicular to said axial center line.

4. The fishing line sinker as defined in claim 1 in which said fishing line-receiving bore extends at an angle of about 10 degrees relative to line extending perpendicular to said axial center line.

5. The fishing line sinker as defined in claim 1 in which said fishing line-receiving bore extends at an angle of about 20 degrees relative to line extending perpendicular to said axial center line.

6. The fishing line sinker as defined in claim 1 in which said fishing line-receiving bore extends at an angle of about 60 degrees relative to line extending perpendicular to said axial center line.

7. A fishing line sinker for use with a fishing line comprising an elongated, generally cylindrically shaped body having an axial center line, an upper portion, a central portion and a lower portion, said upper portion being provided with a first angularly extending fishing line receiving bore for slidably receiving the fishing line, said angularly extending fishing line receiving bore extending at an angle between about 10 degrees and about 60 degrees relative to line extending perpendicular to said axial center line.

8. The fishing line sinker as defined in claim 7 in which said central portion is provided with a second angularly extending fishing line receiving bore.

9. The fishing line sinker as defined in claim 7, further including securement means for preventing said fishing line sinker from sliding along the fishing line.

10. The fishing line sinker as defined in claim 9 in which said securement means comprises a rubber securement device disposed within said fishing line receiving bore.

11. The fishing line sinker as defined in claim 9 in which said first and second ends are rounded.
